(19) United States
(12) Patent Application Publication
(10) Pub. No.: US 2010/0123785 A1
(43) Pub. Date: May 20, 2010

(54) Graphic Control for Directional Audio Input

(75) Inventors: Shaohai Chen, Cupertino, CA (US); Philip George Tamchina, Mountain View, CA (US); Jae Han Lee, San Jose, CA (US); Chad G. Seguin, Morgan Hill, CA (US); Michael Lee, San Jose, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(73) Assignee: APPLE INC., Cupertino, CA (US)

(21) Appl. No.: 12/272,650

(22) Filed: Nov. 17, 2008

(51) Int. Cl. H04N 5/228; H04R 3/00; G06F 3/048; G06K 9/00

(52) U.S. Cl. 348/207.11; 381/92; 382/118; 715/716; 348/E05.031

(57) ABSTRACT

A device to provide an audio output includes a microphone array, a signal processor, and a graphic user interface (GUI). The signal processor is coupled to the microphone array to perform audio beamforming with input from the microphone array. The GUI is coupled to the signal processor to display a plurality of audio sources, to receive a selection of at least one of the plurality of audio sources from a user, and to provide the selection to the signal processor for aiming the audio beamforming toward the selected audio source. The selection may be made by touching the display. The device may further include a camera and the GUI may display an image received from the camera as the plurality of audio sources. The camera may provide a moving video image and the signal processor may provide a synchronized audio signal aimed at the selected audio source.

### BACKGROUND

1. Field

Embodiments of the invention relate to the field of audio beamforming; and more specifically, to the aiming of audio beamforming.

2. Background

Under typical imperfect conditions, a single microphone that is embedded in a mobile device does a poor job of capturing sound because of background sounds that are captured along with the sound of interest. An array of microphones can do a better job of isolating a sound source and rejecting ambient noise and reverberation.

Beamforming is a way of combining sounds from two or more microphones that allows preferential capture of sounds coming from certain directions. In a delay-and-sum beamformer sounds from each microphone are delayed relative to sounds from the other microphones, and the delayed signals are added. The amount of delay determines the beam angle—the angle in which the array preferentially “listens.” When a sound arrives from this angle, the sound signals from the multiple phones are added constructively. The resulting sum is stronger, and the sound is received relatively well. When a sound arrives from another angle, the delayed signals from the various microphones add destructively—with positive and negative parts of the sound waves canceling out to some degree—and the sum is not as loud as an equivalent sound arriving from the beam angle.

For example, if the sound comes into the microphone on the right before it enters the microphone on the left, then you know the sound source is to the right of the microphone array. During sound capturing, the microphone array processor can aim a capturing beam in the direction of the sound source. Beamforming allows a microphone array to simulate a highly directional microphone pointing toward the sound source. The directivity of the microphone array reduces the amount of captured ambient noises and reverberated sound as compared to a single microphone. This may provide a clearer representation of a speaker's voice.

A beamforming microphone array may made up of distributed omnidirectional microphones linked to a processor that combines the several inputs into an output with a coherent form. Arrays may be formed using numbers of closely spaced microphones. Given a fixed physical relationship in space between the different individual microphone transducer array elements, simultaneous digital signal processor (DSP) processing of the signals from each of the individual microphones in the array can create one or more “virtual” microphones. Different algorithms permit the creation of virtual microphones with extremely complex virtual polar patterns and even the possibility to steer the individual lobes of the virtual microphones patterns so as to home-in-on, or to reject, particular sources of sound. Beamforming techniques, however, rely on knowledge of the location of the sound source. Therefore it is necessary to aim the beamforming at the intended sound source to benefit from the use of a microphone array.

### SUMMARY

A device to provide an audio output includes a microphone array, a signal processor, and a graphic user interface (GUI). The signal processor is coupled to the microphone array to perform audio beamforming with input from the microphone array. The GUI is coupled to the signal processor to display a plurality of audio sources, to receive a selection of at least one of the plurality of audio sources from a user, and to provide the selection to the signal processor for aiming the audio beamforming toward the selected audio source. The selection may be made by touching the display. The device may further include a camera and the GUI may display an image received from the camera as the plurality of audio sources. The camera may provide a moving video image and the signal processor may provide a synchronized audio signal aimed at the selected audio source.

Other features and advantages of the present invention will be apparent from the accompanying drawings and from the detailed description that follows below.

### BRIEF DESCRIPTION OF THE DRAWINGS

The invention may best be understood by referring to the following description and accompanying drawings that are used to illustrate embodiments of the invention by way of example and not limitation. In the drawings, in which like reference numerals indicate similar elements:

FIG. 1 is a block diagram of a device in a typical environment for use.

FIG. 2 is a block diagram of an implementation of the signal processor shown in FIG. 1.

FIGS. 3 through 9 are alternate displays on the graphic user interface shown in FIG. 1.

FIGS. 10 and 11 are conceptual polar diagrams of microphone pickups that might result from the source selections shown in FIGS. 8 and 9.

FIG. 12 is an alternate display on the graphic user interface shown in FIG. 1.

FIG. 13 is a conceptual polar diagram of microphone pickup that might result from the source selections shown in FIG. 12.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

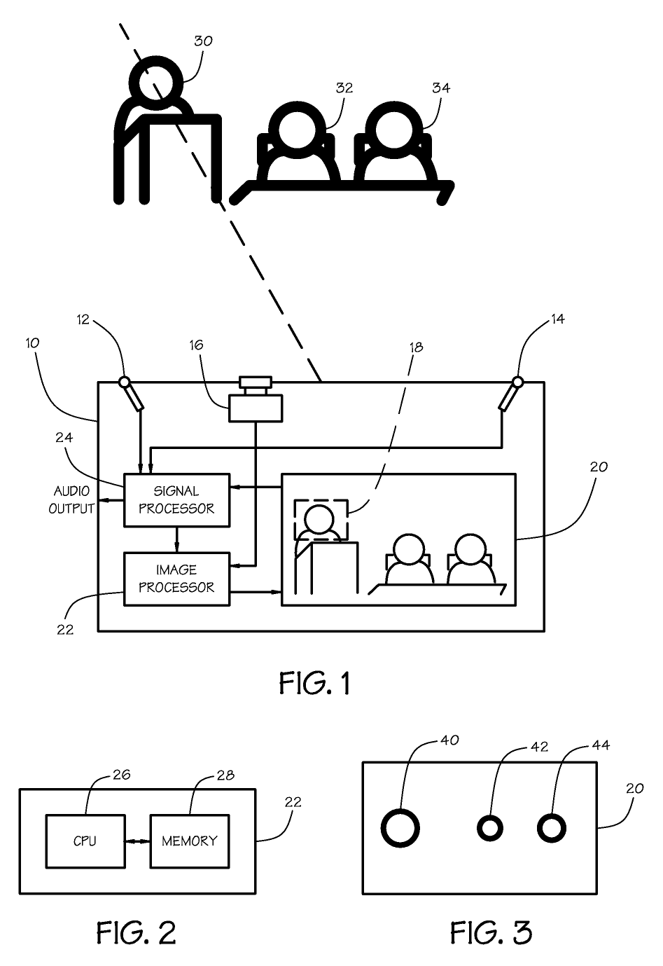

FIG. 1 shows a device 10 that provides an audio output. The device may be a mobile device such as a cellular telephone, a camera with an audio recorder, or a video recorder. The device 10 includes a microphone array 12,14. Microphones in the array may be omnidirectional microphones or they may have a directional pickup pattern. Each of the microphones may be one of an electret condenser microphone (ECM), a micro-electro-mechanical systems (MEMS), or other technology microphone, particularly a technology that provides microphones of a small size.

A signal processor 24 is coupled to the microphone array to produce the audio output using audio beamforming with input from the microphone array. FIG. 2 shows an embodiment of the signal processor 24 that includes a central processing unit (CPU) 26 coupled to a memory 28. The memory includes instructions which, when executed by the CPU 26, provide the audio beamforming function of the signal processor 24. It will be appreciated that the CPU 26 may perform additional functions that may or may not be related to the audio beamforming.

FIG. 1 further shows a graphic user interface (GUI) 20 coupled to the signal processor 24. The GUI 20 displays an image of a plurality of audio sources such as the exemplary group of speakers 30, 32, 34 shown in the figure. The GUI 20 further receives a selection 18 of at least one of the plurality of audio sources from a user. The GUI 20 provides the selection to the signal processor 24 for aiming the audio beamforming toward the selected audio source 30 as suggested by the dashed line.

The signal processor 24 may identify a spatial arrangement of sounds received by the microphone array 12, 14 and provides the spatial arrangement to the GUI 20. The GUI may display a graphic representation of the spatial arrangement of audio sources as the image of the plurality of audio sources. The spatial arrangement identified by the signal processor 24 may be in the form of a plurality of beamforming angles that are directed to the plurality of audio sources. The spatial arrangement may identify only one dimension. Therefore, the graphic representation of the spatial arrangement of audio sources may be a somewhat abstract representation.

FIG. 3 shows the GUI 20 displaying a representation of each audio source in a linear arrangement that suggests their position across the range of beamforming angles. Graphic indicator 40 represents speaker 30 shown in FIG. 1. Likewise indicator 42 represents speaker 32 and indicator 44 represents speaker 34. The graphic representation of the spatial arrangement of audio sources may include an indication of the average volume of the audio source by means such as size, intensity, color, or the like. For example, in FIG. 3 the leftmost graphic indicator 40 is large to suggest a loud audio source while the middle indicator 42 is small to indicate a quiet audio source. The rightmost indicator 44 is of medium size to indicate a sound volume between that indicated by the other two indicators 40, 42.

As shown in FIG. 1, the device 10 may include a camera 16 coupled to the GUI 20. The GUI may display an image received from the camera 16 as the image of the plurality of audio sources for selection 18 by the user. The selection may be made by touching the image on the GUI or by a pointing device such as a trackball or joystick.

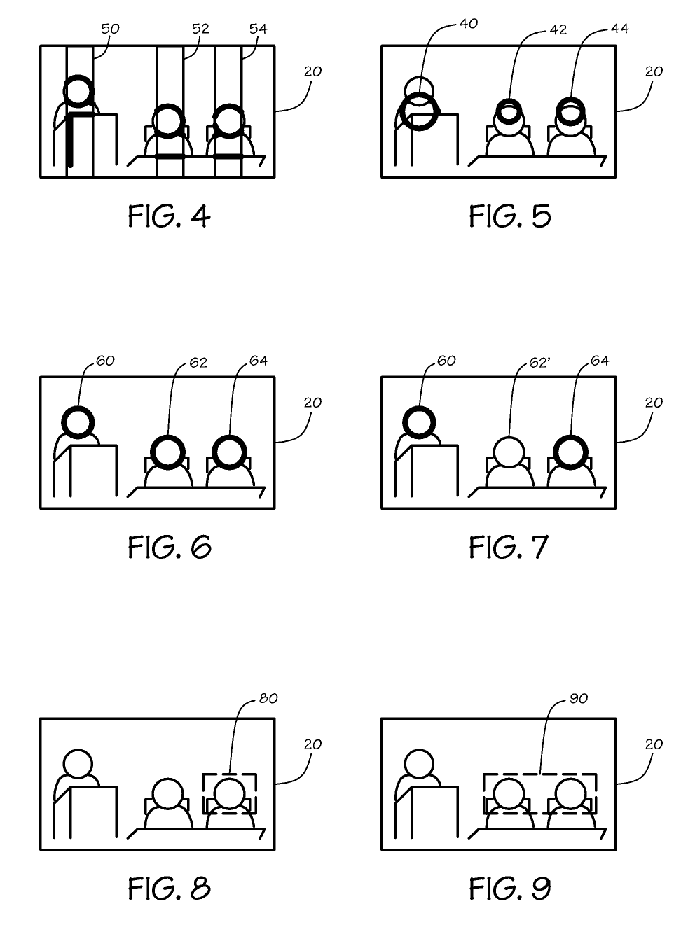

The signal processor 24 may identify a spatial arrangement of sounds received by the microphone array 12, 14 and provide the spatial arrangement to the GUI 20. As shown in FIG. 4, The GUI 20 may enhance the image 50, 52, 54 received from the camera 16 based on the spatial arrangement to suggest the audio sources within the image. The enhancements may further suggest the relative volume of the audio sources by means such as size, intensity, color, or the like. Alternatively, as shown in FIG. 5, the GUI 20 may display the graphic representation 40, 42, 44 of the spatial arrangement of audio sources as an overlay on the image received from the camera 16 as the image of the plurality of audio sources for selection by the user.

As shown in FIG. 1, the device 10 may include an image processor 22 coupled to the camera 16 and the GUI 20. The image processor 22 may identify faces in the image received from the camera 16. The memory 28 shown in FIG. 2 may further include instructions which, when executed by the CPU 26, provide the face recognition function of the image processor 22.

As shown in FIG. 6, the GUI 20 may display the identified faces 60, 62, 64 in the image as selectable audio sources. The identified faces 60, 62, 64 may be indicated by a variety of means such as an outline, presenting the identified faces lighter than the remaining image, presenting the identified faces in color with the remaining image in black and white, etc.

The image processor 22 may receive the spatial arrangement of sounds received by the microphone array 12, 14 identified by the signal processor 24. As shown in FIG. 7, the image processor 22 may limit the face identification to faces that correspond to audio sources identified by the signal processor 24. In the example shown, the image of the middle speaker 62′ may not be identified as a selectable audio source if the volume of sound received from that direction is below a sound level threshold for identifying audio sources. The GUI 20 may provide a way of selecting a audio source other than one identified by the signal processor 24.

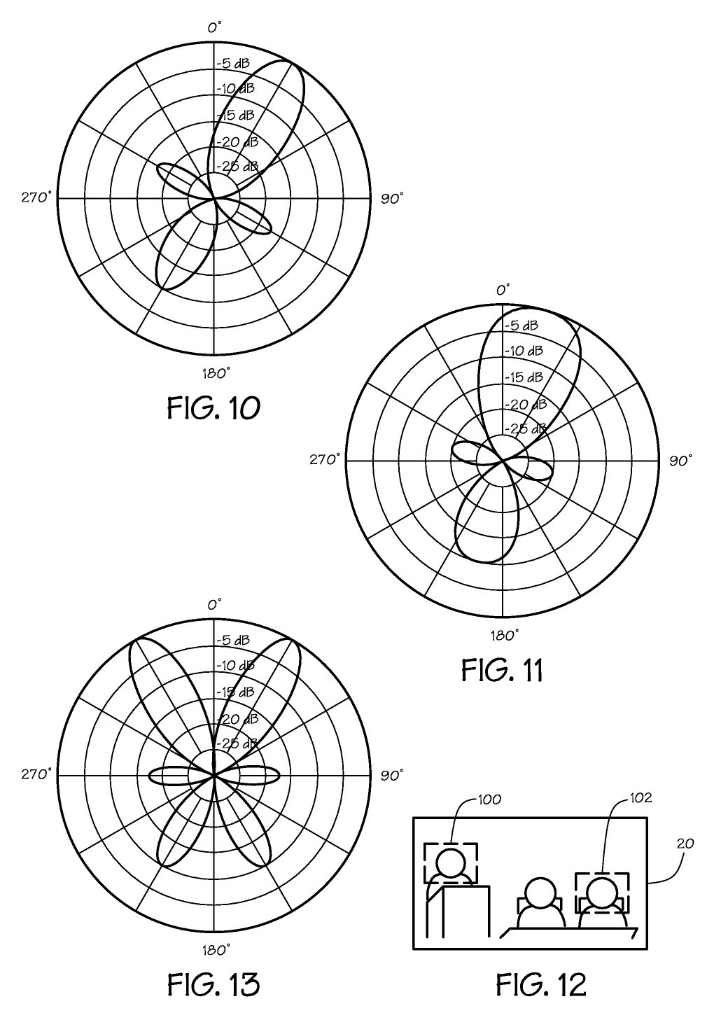

As shown in FIGS. 8 and 9, the GUI 20 may receive a size associated with the selection 80, 90 of the audio source. The signal processor 24 may adjust a front lobe size according to the size associated with the selection of the audio source. FIG. 8 shows a selection 80 of one person as the audio source at which the beam forming is aimed, which would cause the front lobe to be adjusted to provide a highly directional audio input as shown in the polar pattern of microphone pickup of FIG. 10.

FIG. 9 shows a selection 90 of two adjacent people as the audio source at which the beam forming is aimed, which would cause the front lobe to be adjusted to provide a less directional audio input suitable for receiving a conversation between the two people as shown in the polar pattern of microphone pickup of FIG. 11. (It should be noted that FIGS. 10 and 11 are conceptual illustrations of microphone pickup patterns and may not represent patterns that could be obtained with any particular microphone array.)

It will be appreciated that the selection on the GUI 20 may provide a width and a height of the audio source at which the beamforming is to be aimed but the beamforming may be responsive to one dimension of the selection such as the width.

As shown in FIG. 12, the GUI may permit selections 100, 102 of two or more of the plurality of audio sources from the user. The selection of more than one audio source may cause the signal processor to search for voice activity only among the selected two or more of the plurality of audio sources. In another embodiment, the signal processor may provide for simultaneously receiving audio from audio sources in more than one direction by providing a virtual microphone with more than one prominent lobe as shown in the polar pattern of microphone pickup of FIG. 13 or by providing more than one signal processing path to provide more than one virtual microphone. (It should be noted that FIG. 13 is a conceptual illustration of a microphone pickup pattern and may not represent a pattern that could be obtained with any particular microphone array.)

The device may be a camera that provides a moving video image with the signal processor providing a synchronized audio signal aimed at the selected audio source as the audio output. In other embodiments, the camera, if present, may be used only to provide images to the image processor to assist in the aiming of the audio beamforming with the device providing only an audio output aimed at the selected audio source.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those of ordinary skill in the art. The description is thus to be regarded as illustrative instead of limiting.

What is claimed is:

1. A device to provide an audio output, the device comprising:
a microphone array;
a signal processor coupled to the microphone array to produce the audio output using audio beamforming with input from the microphone array;
a graphic user interface (GUI) coupled to the signal processor, the GUI to display an image of a plurality of audio sources, to receive a selection of at least one of the plurality of audio sources from a user, and to provide the selection to the signal processor for aiming the audio beamforming toward the selected audio source.

2. The device of claim 1, wherein the signal processor is to identify a spatial arrangement of sounds received by the microphone array and provides the spatial arrangement to the GUI, the GUI to display a graphic representation of the spatial arrangement as the image of the plurality of audio sources.

3. The device of claim 1 further comprising a camera coupled to the GUI, the GUI to display an image received from the camera as the image of the plurality of audio sources.

4. The device of claim 3 further comprising an image processor coupled to the camera and the GUI, the image processor to identify faces in the image received from the camera, the GUI to display the identified faces in the image of the plurality of audio sources as selectable audio sources.

5. The device of claim 3, wherein the camera provides a moving video image and the signal processor provides a synchronized audio signal aimed at the selected audio source as the audio output.

6. The device of claim 1, wherein the GUI is to further receive a size associated with the selection of the audio source and the signal processor adjusts a front lobe size according to the size associated with the selection of the audio source.

7. The device of claim 1, wherein the GUI is to further receive selections of two or more of the plurality of audio sources from the user.

8. The device of claim 7, wherein the signal processor further searches for voice activity only among the selected two or more of the plurality of audio sources.

9. The device of claim 1, wherein the selection is made by touching the image on the GUI.

10. The device of claim 1, further comprising a central processing unit (CPU) coupled to a memory, the memory including instructions which, when executed by the CPU, provide the audio beamforming.

11. A method for aiming audio beamforming, the method comprising:
displaying an image of a plurality of audio sources;
receiving a selection of at least one of the plurality of audio sources;
beamforming a plurality of audio inputs from a microphone array to produce an audio output; and
aiming the audio beamforming toward the selected audio source.

12. The method of claim 11 further comprising:
identifying a spatial arrangement of sounds received by the microphone array; and
displaying a graphic representation of the spatial arrangement as the image of the plurality of audio sources.

13. The method of claim 11 further comprising displaying an image received from a camera as the image of the plurality of audio sources.

14. The method of claim 13 further comprising:
identifying faces in the image received from the camera; and
displaying the identified faces in the image of the plurality of audio sources as selectable audio sources.

15. The method of claim 13 further comprising:
providing a moving video image from the camera; and
providing a synchronized audio signal aimed at the selected audio source.

16. The method of claim 11 further comprising:
receiving a size associated with the selection of the audio source; and
adjusting a front lobe size according to the size associated with the selection of the audio source.

17. The method of claim 11 further comprising receiving selections of two or more of the plurality of audio sources from the user.

18. The method of claim 17 further comprising searching for voice activity only among the selected two or more of the plurality of audio sources.

19. A device for aiming audio beamforming, the device comprising:
means for displaying an image of a plurality of audio sources;
means for receiving a selection of at least one of the plurality of audio sources;
means for beamforming a plurality of audio inputs from a microphone array to produce an audio output; and
means for aiming the audio beamforming toward the selected audio source.

20. The device of claim 19 further comprising:
means for identifying a spatial arrangement of sounds received by the microphone array; and
means for displaying a graphic representation of the spatial arrangement as the image of the plurality of audio sources.

21. The device of claim 19 further comprising means for displaying an image received from a camera as the image of the plurality of audio sources.

22. The device of claim 21 further comprising:
means for identifying faces in the image received from the camera; and
means for displaying the identified faces in the image of the plurality of audio sources as selectable audio sources.

23. The device of claim 21 further comprising:
means for providing a moving video image from the camera; and
means for providing a synchronized audio signal aimed at the selected audio source.

24. The device of claim 19 further comprising:
means for receiving a size associated with the selection of the audio source; and
means for adjusting a front lobe size according to the size associated with the selection of the audio source.

25. The device of claim 19 further comprising means for receiving selections of two or more of the plurality of audio sources from the user.

26. The device of claim 25 further comprising means for searching for voice activity only among the selected two or more of the plurality of audio sources.
